(19) United States
(12) Patent Application Publication
(10) Pub. No.: US 2015/0093480 A1
(43) Pub. Date: Apr. 2, 2015

(54) Barbecue Seasoning Utensil

(71) Applicant: Flavor Fork Inc., Victoria (CA)

(72) Inventor: Troy Biever, Victoria (CA)

(21) Appl. No.: 14/389,975

(22) PCT Filed: Apr. 4, 2013
(86) PCT No.: PCT/CA2013/000324

§ 371 Date: Oct. 1, 2014

Related U.S. Application Data
(60) Provisional application No. 61/620,610, filed on Apr. 5, 2012.

(51) Int. Cl. A47J 37/07; A47J 37/10; A47J 43/28

(52) U.S. Cl. CPC A47J 37/0786; A47J 43/288; A47J 37/106
USPC 426/281; 30/125; 7/112; 7/151; 99/532; 15/159.1; 294/7

(57) ABSTRACT

A barbecue utensil having a hollow cylindrical handle with a plunger access opening along the back side of the handle; food handling means removably attachable by an adapter to the bottom end of the handle; and a fluid syringe having a plunger at a top end and a fluid outlet at a bottom end, the syringe reversibly insertable into the bottom end of the handle, wherein the fluid outlet is reversibly connectable to the top end of the food handling means, which may be a fork, basting brush or spatula, for discharge of a fluid seasoning from a syringe into or onto a food item. A food thermometer or grill cleaning brush may also be attached to the handle.

### FIELD OF THE INVENTION

The present invention relates to food preparation. In particular, the present invention relates to a utensil for use in barbecue cooking.

### SUMMARY OF THE INVENTION

There is provided a barbecue utensil having a hollow cylindrical handle having top and bottom ends, front and back sides, and a plunger access opening along the back side of the handle; food handling means removably attachable by an adapter to the bottom end of the handle; and a fluid syringe having a plunger at a top end and a fluid outlet at a bottom end, the syringe reversibly insertable into the bottom end of the handle, wherein the fluid outlet is reversibly connectable to the top end of the food handling means.

The food handling means may be a fork having a hollow manifold and a plurality of hollow cylindrical tines extending from the manifold for delivery of fluid from the syringe to the lower end of the tines. The fork preferably has three tines, which may be curved upwards at their distal ends.

The food handling means may be a basting brush, which may be manufactured of silicone and may have a central bore for delivery of fluid from the syringe to the lower end of the brush. The food handling means may be a spatula, which may be manufactured of stainless steel or other suitable material. The handle further may have an opening on its front side in proximity to the lower end. The fluid syringe may be transparent, and may have volume gradations on its outer surface.

A fluid dispensed from the fluid syringe may pass directly from the fluid syringe into the food handling means without coming into contact with the handle.

The barbecue utensil may have hook means at the top end of the handle for hanging the utensil from a support. The attachment adapter may be manufactured of silicone. There also may be a bottle opener attached to the handle.

There is further provided a barbecue seasoning utensil kit having a handle, a fork, a basting brush, and a spatula individually attachable to the handle, each of the fork, basting brush and spatula interchangeable with one another; and a plurality of fluid syringes, each insertable into the handle for fluid communication with the fork, basting brush or spatula. A food thermometer and a grill cleaning brush may also be provided.

There is also provided a method of seasoning food comprising the steps of: (a) filling each of a plurality of fluid syringes with a desired seasoning fluid; (b) inserting a first fluid syringe into a barbecue fork utensil; (c) inserting the fork into a food item; (d) depressing the plunger of the fluid syringe a desired distance to discharge a desired volume of fluid into the food item; (e) removing the fork from the food item; (f) replacing the first fluid syringe with a subsequent syringe; and (g) repeating steps (d), (e), and (f) until seasoning is complete.

There is provided a method of basting a food item comprising the steps of: (a) filling each of a plurality of fluid syringes with a desired seasoning fluid; (b) inserting a first fluid syringe into a barbecue basting brush utensil; (c) brushing the food item with the basting brush while depressing the plunger of the fluid syringe a desired distance to discharge a desired volume of fluid onto the food item; (d) replacing the first fluid syringe with a subsequent fluid syringe; and (e) repeating steps (b) and (c) until basting is complete.

### BRIEF DESCRIPTION OF THE DRAWINGS

A detailed description of the preferred embodiments is provided below by way of example only and with reference to the following drawings, in which:

FIG. 1 is a front view of a preferred embodiment of the barbecue fork utensil of the present invention;

FIG. 2 is a side view of a preferred embodiment of the barbecue fork utensil of the present invention;

FIG. 3 is a rear view of a preferred embodiment of the barbecue fork utensil of the present invention;

FIG. 4 is a front view of a preferred embodiment of the barbecue basting brush utensil of the present invention;

FIG. 5 is a side view of a preferred embodiment of the barbecue basting brush utensil of the present invention;

FIG. 6 is a rear view of a preferred embodiment of the barbecue basting brush utensil of the present invention;

FIG. 7 is a front view of a preferred embodiment of the barbecue spatula utensil of the present invention;

FIG. 8 is a side view of a preferred embodiment of the barbecue spatula utensil of the present invention;

FIG. 9 is a rear view of a preferred embodiment of the barbecue spatula utensil of the present invention;

FIG. 10 is a perspective view of the disassembled fork attachment and fork adapter head;

FIG. 11 is a perspective view of the disassembled basting brush attachment and brush adapter head;

FIG. 12 is a perspective view of the disassembled spatula attachment and spatula adapter head;

FIG. 13 is a perspective view of the barbecue utensil with the fork attachment in a locked position; and

FIG. 14 is a perspective view of the barbecue utensil with the fork attachment in an unlocked position.

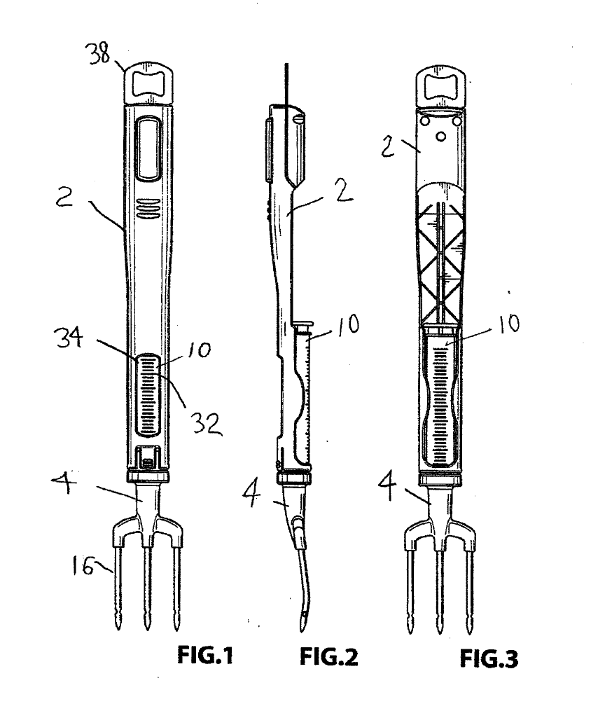

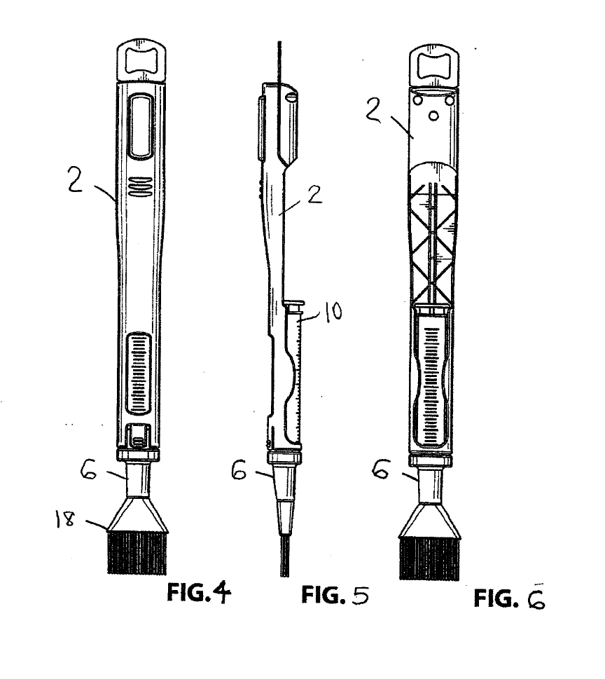

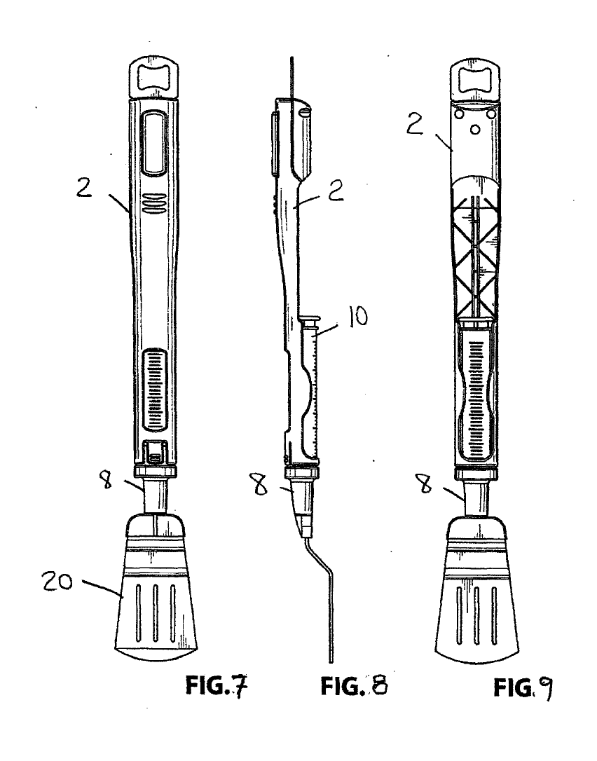

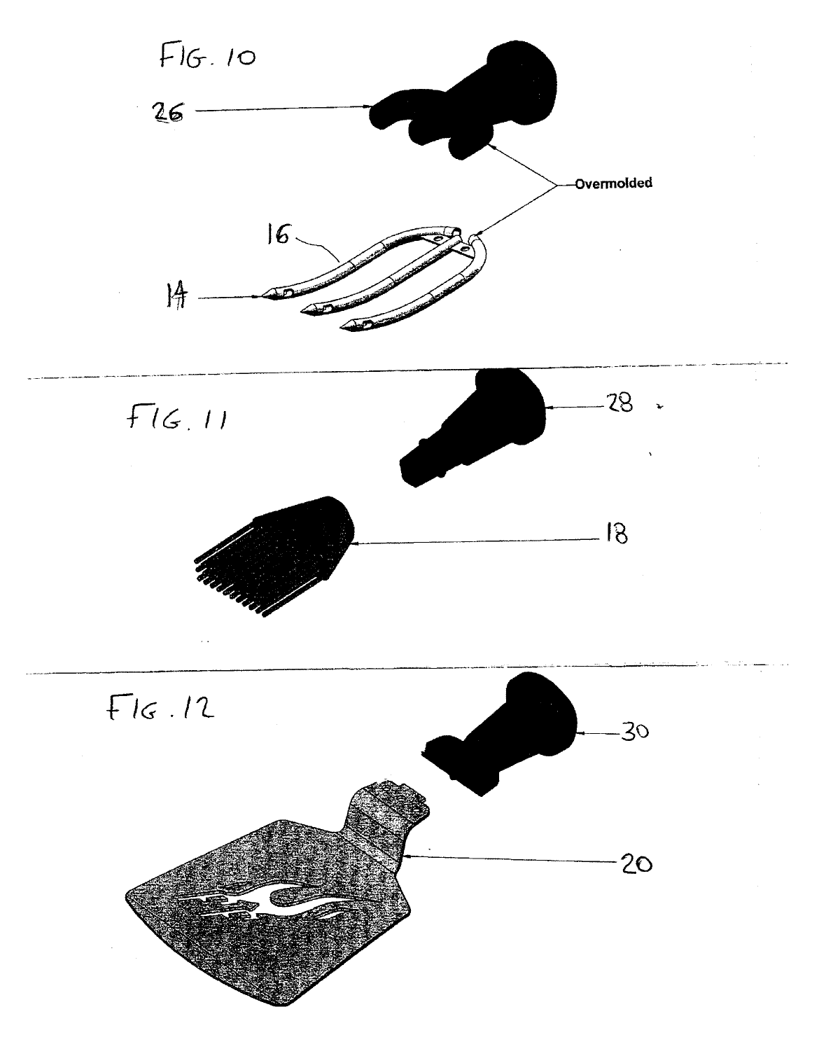

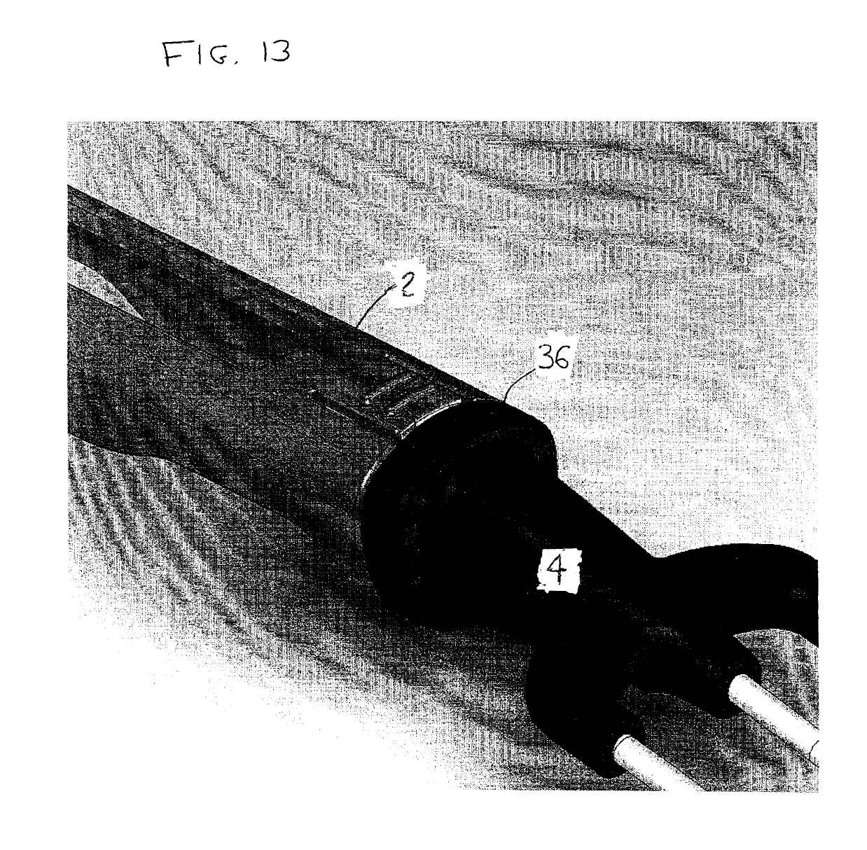

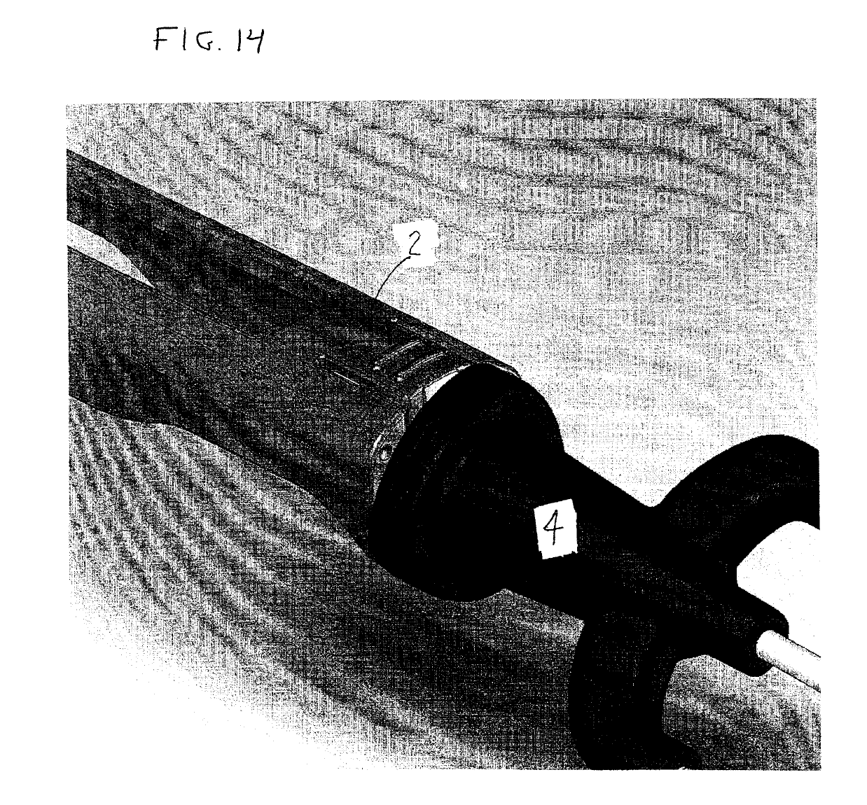

In the drawings, certain embodiments of the invention are illustrated by way of example. It is to be expressly understood that the description and drawings are only for the purpose of illustration and as an aid to understanding, and are not intended as a definition of the limits of the invention.

### DESCRIPTION OF THE INVENTION

As shown in the figures, there is provided a barbecue utensil for use in barbecue cooking. The utensil may be converted between a fork, a basting brush and a spatula.

The primary components of the utensil include a handle 2, a food handling head attachment 4, 6, 8, and a fluid injection device, or syringe 6. The syringe is housed within the handle and the outlet of the contained fluid is in proximity to the head attachment. The head attachment may be any one of a three-pronged fork 16 having hollow tines 14, a basting brush 18, a spatula 20, a food thermometer, or a grill cleaning blush, each having an associated adapter 26, 28, 30 for attachment to the bottom end of the handle.

In the preferred embodiment, each tine of the fork is hollow with an opening at its distal end to permit a seasoning fluid to be injected into the meat or other food being barbecued. The tines of the fork may be curved upwardly at their distal ends to assist in lifting or turning of the food being prepared.

The fluid syringe is removable from the handle for cleaning and filling, and preferably is transparent. The syringe may be filled with any fluid to be used for dispensing onto or into food during cooking to enhance the flavor of the food. The fluid syringe may be a transparent syringe having gradations 32 on the outside surface to permit identification of the flavoring liquid, and to allow accurate measurement of volumes to be injected. An opening 34 or window may be provided in the front side of the handle to allow viewing of the syringe and its contents. A plurality of fluid syringes may be prepared in advance to allow injection of a plurality of seasoning fluids during a barbecue cooking session.

Access to the fluid injection device may be through removal of a locking head attachment mechanism 36 known in the prior art. For example, rotation of the head attachment may permit removal of the head attachment from the handle to allow the fluid syringe to be removed from the handle for filling, cleaning or substitution with a second fluid syringe. The attachment may be rotated into a locking position for reattachment.

Preferably, the basting brush and all food handling head attachment adapters are manufactured of silicone to permit use in high temperatures without damage to the utensil. The spatula, fork, food thermometer and grill brush attachments may be manufactured of a suitable metal.

A barbecue fork attachment having a single tine or two tines is also within the scope of the invention.

The barbecue utensil kit may include accessories such as a hook to permit hanging of the utensil in a convenient location in proximity to a barbecue apparatus. A bottle opener attachment 38 may also be incorporated to permit opening of bottled beverages or seasoning containers.

The barbecue utensil may be fully and quickly disassembled for cleaning to maintain the highest standards of cleanliness and food safety.

When the utensil is used with the grill cleaning brush attachment, a syringe may be filled with water or other grill cleaning fluid to aid in grill cleaning.

As many possible embodiments may be made of the invention without departing from the scope of the claims, it is to be understood that all matter herein set forth or shown in the accompanying drawings is to be interpreted as illustrative and not in a limiting sense. It will be appreciated by those skilled in the art that other variations of the preferred embodiment may also be practised without departing from the scope of the invention.

1. A barbecue utensil comprising:
a hollow cylindrical handle having top and bottom ends, front and back sides, and a plunger access opening along the back side of the handle;
food handling means removably attachable by an adapter to the bottom end of the handle; and
a fluid syringe having a plunger at a top end and a fluid outlet at a bottom end, the syringe reversibly insertable into the bottom end of the handle, wherein the fluid outlet is reversibly connectable to the top end of the food handling means.

2. The barbecue utensil of claim 1, wherein the food handling means comprises a fork having a hollow manifold and one or more hollow cylindrical tines extending from the manifold for delivery of fluid from the syringe to the lower end of the tines.

3. The barbecue utensil of claim 2, wherein the plurality of times comprises at least three tines.

4. The barbecue utensil of claim 3, wherein the tines of the fork are curved towards the front side of the handle.

5. The barbecue utensil of claim 1, wherein the food handling means comprises a basting brush.

6. The barbecue utensil of claim 5, wherein the basting brush is manufactured of silicone.

7. The barbecue utensil of claim 5, wherein the basting brush further comprises a central bore for delivery of fluid from the syringe to the lower end of the brush.

8. The barbecue utensil of claim 1, wherein the food handling means comprises a spatula.

9. The barbecue utensil of claim 1, wherein the food handling means comprises a food thermometer.

10. The barbecue utensil of claim 1, wherein the food handling means may be replaced with a grill cleaning brush.

11. The barbecue utensil of claim 1, wherein the handle further comprises an opening on its front side in proximity to the lower end.

12. The barbecue utensil of claim 11, wherein the fluid syringe is transparent.

13. The barbecue utensil of claim 12, wherein the fluid syringe further comprises volume gradations on its outer surface.

14. The barbecue utensil of claim 1, wherein a fluid dispensed from the fluid syringe passes directly from the fluid syringe into the food handling means without coming into contact with the handle.

15. The barbecue utensil of claim 1, wherein the adapter is manufactured of silicone.

16. The barbecue utensil of claim 1, further comprising a bottle opener attached to the handle.

17. A barbecue seasoning utensil kit comprising:
the barbecue utensil of claim 1, wherein the food handling means comprises a fork, a basting brush, and a spatula, each of the fork, basting brush and spatula interchangeable with one another; and
a plurality of fluid syringes.

18. The barbecue seasoning utensil kit of claim 17, further comprising a food thermometer and a grill cleaning brush, each interchangeable with the other attachments.

19. A method of seasoning food comprising the steps of:
a) filling each of a plurality of fluid syringes with a desired seasoning fluid;
b) inserting a first fluid syringe into the barbecue utensil of claim 2;
c) inserting the fork into a food item;
d) depressing the plunger of the fluid syringe a desired distance to discharge a desired volume of fluid into the food item;
e) removing the fork from the food item;
f) replacing the first fluid syringe with a subsequent syringe; and
g) repeating steps (d), (e), and (f) until seasoning is complete.

20. A method of basting a food item comprising the steps of:
a) filling each of a plurality of fluid syringes with a desired seasoning fluid; inserting a first fluid syringe into the barbecue utensil of claim 6;
b) brushing the food item with the basting brush while depressing the plunger of the fluid syringe a desired distance to discharge a desired volume of fluid onto the food item;
c) replacing the first fluid syringe with a subsequent fluid syringe;
d) repeating steps (b) and (c) until basting is complete.
